(19) United States
(12) Patent Application Publication
(10) Pub. No.: US 2025/0146622 A1
(43) Pub. Date: May 8, 2025

(54) HYDROGEN REFUELING STATION, HYDROGEN-POWERED VEHICLE, AND HYDROGEN REFUELING SYSTEM

(71) Applicant: SUZHOU PROTON ENERGY TECHNOLOGY CO., LTD., Suzhou (CN)

(72) Inventor: Guangsheng XU, Suzhou (CN)

(73) Assignee: SUZHOU PROTON ENERGY TECHNOLOGY CO., LTD., Suzhou (CN)

(21) Appl. No.: 18/631,120

(22) Filed: Apr. 10, 2024

Related U.S. Application Data
(63) Continuation of application No. PCT/CN2024/080220, filed on Mar. 6, 2024.

(30) Foreign Application Priority Data
Nov. 6, 2023 (CN) 202311462741.7
Nov. 6, 2023 (CN) 202311462746.X

(51) Int. Cl. F17C 5/00; B60K 15/03; B60K 15/063; B60S 5/02; C25B 1/04; C25B 9/17; C25B 9/67; C25B 15/021; G06N 5/022; H01M 8/04082; H01M 8/0656

(52) U.S. Cl. CPC F17C 5/007; B60K 15/063; C25B 1/04; C25B 9/17; C25B 9/67; C25B 15/021; G06N 5/022; H01M 8/04201; H01M 8/0656; B60K 2015/03315; B60S 5/02; F17C 2205/013; F17C 2221/012; F17C 2227/0302; F17C 2250/03; F17C 2265/065; F17C 2270/0178; F17C 2270/0184; H01M 2250/20

(57) ABSTRACT

Hydrogen refueling station, hydrogen-powered vehicle, and hydrogen refueling system are provided. The hydrogen refueling system comprises a decomposition device, a transfer device, a storage device, and a recombination device; wherein the decomposition device is configured to decompose water into hydrogen and oxygen; the transfer device is configured to deliver the hydrogen into the storage device and to discharge the oxygen into an environment; the storage device is configured to store the hydrogen delivered from the transfer device; the recombination device is configured to receive the hydrogen from the storage device and the oxygen from the environment, the hydrogen and oxygen reacting in the recombination device to produce an electric current. The hydrogen refueling system adopts real-time hydrogen production and refueling, thereby eliminating the need to construct large hydrogen storage tanks, and the need for the long-distance transportation of the hydrogen.

### CROSS-REFERENCE TO RELATED APPLICATIONS

This application is a Continuation of International Application No. PCT/CN2024/080220, filed on Mar. 6, 2024, which claims priority to Chinese patent application No. 202311462746.X filed on Nov. 6, 2023 and Chinese patent application No. 202311462741.7 filed on Nov. 6, 2023, the entire contents of which are incorporated herein by reference.

### TECHNICAL FIELD

The present disclosure relates to the field of hydrogen refueling technology, and in particular relates to a hydrogen refueling station, a hydrogen-powered vehicle, and a hydrogen refueling system.

### BACKGROUND

Hydrogen-powered vehicles use hydrogen fuel cells as the power cell, and hydrogen fuel cells work requires hydrogen to participate in the reaction, so it is necessary to build hydrogen refueling stations for the hydrogen-powered vehicles. At present, the hydrogen needs to be transported to a hydrogen refueling station by a long-pipe trailer, a liquid hydrogen tanker, or a pipeline, and then compressed, stored, and refueled at this station. This creates problems with hydrogen transportation and hydrogen storage, leading to higher construction costs for the hydrogen refueling stations, and certain safety risks.

Therefore, in response to the above problem, it is necessary to provide a hydrogen refueling station, a hydrogen-powered vehicle, and a hydrogen refueling system.

### SUMMARY

One or more embodiments of the present disclosure provide a hydrogen refueling station. The hydrogen refueling station is used for refueling a hydrogen-powered vehicle; comprising a hydrogen refueling parking area, where a decomposition device and a transfer device are provided, wherein the decomposition device is configured to decompose water into hydrogen and oxygen when the hydrogen-powered vehicle is located in the hydrogen refueling parking area; the hydrogen is delivered to a storage device of the hydrogen-powered vehicle, and the oxygen is discharged into an environment, via the transfer device.

One or more embodiments of the present disclosure provide a hydrogen-powered vehicle. The hydrogen-powered vehicle is capable of receiving hydrogen supplied from the hydrogen refueling station comprises a storage device and a recombination device, wherein the storage device is configured to store hydrogen provided by the hydrogen refueling station; there combination device is configured to receive hydrogen provided by the storage device as well as oxygen from the environment, the hydrogen and oxygen reacting in the recombination device to produce an electric current.

One or more embodiments of the present disclosure provide a hydrogen refueling system, the hydrogen refueling system comprises: a decomposition device, a transfer device, a storage device, and a recombination device; wherein the decomposition device is configured to decompose water into hydrogen and oxygen; the transfer device is configured to deliver the hydrogen into the storage device and to discharge the oxygen into the environment; the storage device is configured to deposit the hydrogen delivered from the transfer device; the recombination device being configured to receive the hydrogen from the storage device and oxygen from the environment, the hydrogen and oxygen reacting in the recombination device to produce an electric current.

Embodiments of the present disclosure include at least the following beneficial effects. The hydrogen refueling system refuels a vehicle by adopting real-time hydrogen production and hydrogen refueling, which does not require the construction of a large hydrogen storage tank, and eliminates the long-distance hydrogen transportation, which significantly reduces the construction cost and operating cost of the hydrogen refueling system. Additionally, the hydrogen refueling system can use an existing electrical grid as the energy source for hydrogen production, which is conducive to the construction and promotion of the hydrogen refueling station, and overcomes the inconvenience of hydrogen refueling for the hydrogen-powered vehicle.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram of a hydrogen refueling station shown in accordance with some embodiments of the present disclosure;

FIG. 2 is a schematic diagram of a hydrogen-powered vehicle shown in accordance with some embodiments of the present disclosure;

FIG. 3 is a schematic diagram of a hydrogen refueling system shown in accordance with some embodiments of the present disclosure;

FIG. 4 is a flowchart of an exemplary process for determining a predicted demand for hydrogen shown in accordance with some embodiments of the present disclosure;

FIG. 5 is a schematic diagram of a chassis from a top view shown in accordance with some embodiments of the present disclosure;

FIG. 6 is a schematic diagram of a structure of a recombination device shown in accordance with some embodiments of the present disclosure;

FIG. 7 is a schematic diagram of the principle of operation of a recombination device shown in accordance with some embodiments of the present disclosure;

FIG. 8 is a schematic diagram of a mounting assembly from a front view shown in accordance with some embodiments of the present disclosure;

FIG. 9 is a schematic diagram of a recombination device from a front view shown in accordance with some embodiments of the present disclosure;

FIG. 10 is a schematic diagram of a recombination device from a side view shown in accordance with some embodiments of the present disclosure;

FIG. 11 is a schematic diagram of a photovoltaic module from a front view shown in accordance with some embodiments of the present disclosure; and

FIG. 12 is a schematic diagram of the structure of the interior of a water storage tank shown in accordance with some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit,” and/or “module” as used herein are used to distinguish different components, elements, parts, sections, or assemblies at different levels. However, the words may be replaced by other expressions if other words can accomplish the same purpose.

As shown in the present disclosure and the claims, unless the context clearly suggests an exception, the words “a”, “an”, “one”, and/or “the” do not refer specifically to the singular form, but may also include the plural form; the plural form can also refer to the singular form. Generally, the terms “including”, “includes”, “include”, “comprise”, “comprises”, and/or “comprising” suggest only the inclusion of clearly identified steps and elements that do not constitute an exclusive list, and the method or device may also include other steps or elements.

Some embodiments of the present disclosure provide a hydrogen refueling station, which may be used to refuel a hydrogen-powered vehicle.

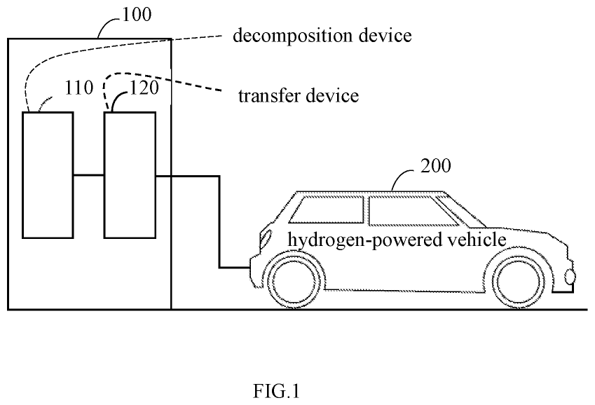

FIG. 1 is a schematic diagram of a hydrogen refueling station shown in accordance with some embodiments of the present disclosure. In some embodiments, the hydrogen refueling station of the present embodiment has a hydrogen refueling parking area that serves as a parking area for a vehicle, as shown in FIG. 1. The hydrogen refueling parking area is provided with a decomposition device 10 and a transfer device 20. The decomposition device 10 is capable of decomposing water into hydrogen and oxygen in real time when a hydrogen-powered vehicle is located in the hydrogen refueling parking area; the hydrogen is capable of being transported to a storage device of the hydrogen-powered vehicle in real time via the transfer device 20; and the oxygen is capable of being discharged into the environment in real time via the transfer device 20. In some embodiments, the decomposition device 10 and the transfer device 20 may be integrated in a housing, with a hydrogen refueling connector of the transfer device 20 extending from the housing to connect to a hydrogen refueling port of the hydrogen-powered vehicle.

The decomposition device 10 refers to a device that decomposes a feedstock to obtain the hydrogen. For example, fossil fuels (e.g., coal, natural gas, etc.) may be the feedstock, and the decomposition device 10 may prepare the hydrogen by chemically reacting the fossil fuels. In some embodiments, the feedstock is water, and the decomposition device 10 uses the principle of electrolysis to produce hydrogen. The basic process of the electrolysis principle is as follows: under the action of an electric current, water is decomposed by electrochemical reaction into the hydrogen and the oxygen, which are precipitated at a cathode and an anode of an electrolyte. In some embodiments, the decomposition device 10 comprises an electrolysis unit; the electrolysis unit comprises: an electrolysis tank, electrodes, and a power source; the electrodes are disposed in the electrolysis tank and connected to the power source; the electrolysis tank can hold water to be electrolyzed. The water is decomposed into hydrogen and oxygen when the electrodes are energized. The hydrogen gas may be delivered to the vehicle by the transfer device 20, and the oxygen may be discharged directly into the environment.

The power source may include a photovoltaic power source, a wind power source, or the like. In some embodiments, the power source may be powered by a power grid. In this way, the hydrogen refueling station may use the existing power grid as the energy source for hydrogen production, which in turn facilitates the construction and promotion of the hydrogen refueling station and overcomes the inconvenience of hydrogen refueling for the hydrogen-powered vehicle. For example, the hydrogen refueling station may be set up in an area such as a residential area, an office area, beside a highway, a gas station, or the like.

The transfer device 20 refers to a device that conveys and transfers the hydrogen and the oxygen. In some embodiments, the transfer device 20 includes: a hydrogen delivery pipeline and an oxygen discharge pipeline; the hydrogen delivery line is connected to the decomposition device 10 at one end and to the storage device at the other end; the oxygen discharge line is connected to the decomposition device 10 at one end and to the environment at the other end. The other end of the hydrogen delivery line may be connected to a hydrogen refueling gun, and the hydrogen refueling gun is capable of delivering the hydrogen to the hydrogen-powered vehicle.

Some embodiments of the present disclosure disclose the hydrogen refueling station adopting a method of real-time delivery of prepared hydrogen to the hydrogen-powered vehicle, which is capable of real-time hydrogen production and the real-time hydrogen refueling, and thus does not require the construction of large-scale hydrogen storage tanks, and at the same time eliminates the need for a long-distance hydrogen transportation, which significantly reduces the construction and operating costs of a hydrogen refueling system.

In some embodiments, the hydrogen refueling station is further provided with a conversion valve and a stationary hydrogen storage tank.

The stationary hydrogen storage tank is a device for storing hydrogen gas set up at the hydrogen refueling station. The stationary hydrogen storage tank may include a high-pressure hydrogen storage tank, a gaseous hydrogen storage tank, a liquid hydrogen storage tank, or the like. Unlike the storage device 30 set on the hydrogen-powered vehicle later, the stationary hydrogen storage tank has a large capacity but is not easy to move.

The conversion valve is a device that controls the direction of hydrogen flow. In some embodiments, the conversion valve is configured to connect the transfer device and the stationary hydrogen storage tank, or to connect the transfer device and the storage device for the hydrogen-powered vehicle. Exemplarily, the conversion valve may be a three-way valve. The three-way valve may comprise 1 inlet and 2 outlets, the inlet connects to the transfer device, one of the outlets connects to the stationary hydrogen storage tank, and the other outlet connects to the storage device of the hydrogen-powered vehicle, and the flow of the hydrogen to the different outlets is controlled by rotating or moving a spool of the three-way valve. When there is no hydrogen-powered vehicle in the aforementioned hydrogen refueling parking area, the transfer device is connected to the stationary hydrogen storage tank, and the hydrogen produced by the decomposition device is stored in the stationary hydrogen storage tank. When the hydrogen-powered vehicle is parked in the hydrogen refueling parking area for the hydrogen refueling, the hydrogen generated by the decomposition device is transferred in real time to the storage device of the hydrogen-powered vehicle.

In some embodiments of the present disclosure, when there is a hydrogen-powered vehicle parked in the hydrogen refueling parking area that needs to be refueled, the produced hydrogen may be delivered to the hydrogen-powered vehicle in real time by using the conversion valve which connects the transfer device and the storage device of the hydrogen-powered vehicle; and when there is no hydrogen-powered vehicle in the hydrogen refueling parking area, the hydrogen produced may be stored in the stationary hydrogen storage tank through the conversion valve connecting the transfer device and the stationary hydrogen storage tank of the hydrogen refueling station, which improves the efficiency of subsequent the hydrogen refueling. By connecting different devices for storing the hydrogen, it facilitates the operator of the hydrogen refueling station to choose different storage devices according to the needs, and improves the efficiency of the hydrogen refueling at the hydrogen refueling station.

In some embodiments, the hydrogen refueling station further includes a control device. The control device is configured to: obtain a hydrogen production cost for the decomposition device; and determine a hydrogen production strategy based on the predicted demand for hydrogen for a hydrogen-powered vehicle in a future time period and the hydrogen production cost.

The hydrogen production cost is the cost of the hydrogen production. In some embodiments, the hydrogen production cost may be determined in multiple ways. For example, the hydrogen production cost may be determined based on a unit manufacturing cost of the hydrogen and the amount of the hydrogen produced. For example, the unit manufacturing cost of the hydrogen may be statistically obtained based on historical data. For example, the historical unit manufacturing cost per hydrogen production may be determined based on the historical hydrogen production cost of multiple hydrogen production and the historical hydrogen production volume in the historical data to determine the historical unit manufacturing cost per hydrogen production, and the unit manufacturing cost of the hydrogen may be determined as a unit manufacturing cost of hydrogen by averaging the multiple historical unit manufacturing costs.

In some embodiments, the hydrogen production cost includes an electricity cost and an equipment cost.

The electricity cost is an electricity cost used by the decomposition device in making the hydrogen.

In some embodiments, the control device may determine the electricity consumption cost based on a price of electricity over different time periods. For example, the control device may determine the electricity consumption cost of (used by) the decomposition device at different time periods based on the power of the decomposition device operating at different time periods, the duration of the operation, and the unit price of the electricity consumption cost at the different time periods, and determine the adorate electricity cost at the different time periods. The sum of the electricity costs of the aforementioned different time periods is determined as the electricity cost of the decomposition device.

The equipment cost is the cost of other necessities required by the hydrogen refueling station to make the hydrogen. For example, the equipment cost may include the cost of lye, etc.

In some embodiments, the equipment cost may be determined by a person of skill in the art or other methods. For example, the equipment cost may be determined based on the volume of lye added and the unit price of the lye.

In some embodiments, the equipment cost may include the depreciation cost of the electrolysis tank and the cost of materials. The depreciation cost of the electrolysis tank is inversely proportional to the operating life of the electrolysis tank. In some embodiments, the correspondence between the depreciation cost of the electrolysis tank and the operating time of the electrolysis tank may be preset based on historical data. The cost of material may include cost of water and cost of ly. In some embodiments, the cost of lye is proportional to the treatment efficiency of the electrolysis tank. For example, the higher the electrolysis efficiency, the more lye is used, and the higher the cost of material. In some embodiments, the correspondence between the cost of lye and the treatment efficiency of the electrolysis tank may be preset based on historical data.

In some embodiments, the control device may determine the sum of the electricity cost and the equipment cost as the hydrogen production cost.

The predicted demand for hydrogen is the total amount of the hydrogen needed at the hydrogen refueling station in a future period of time. In some embodiments, the control device may determine the predicted demand for hydrogen for different future time periods based on historical data. For example, the control device may count the total number of the hydrogen refueling carried out by the hydrogen-powered vehicle at the hydrogen refueling station at a plurality of historical time periods within a day, determine an average total number of hydrogen refueling during the plurality of historical time periods within a day based on the counts over a period of time (e.g., one month, three months, etc.), and then may determine the average total number of hydrogen refueling during the historical time periods belonging to the same time period as a future time period as the predicted demand for hydrogen use in that future time period.

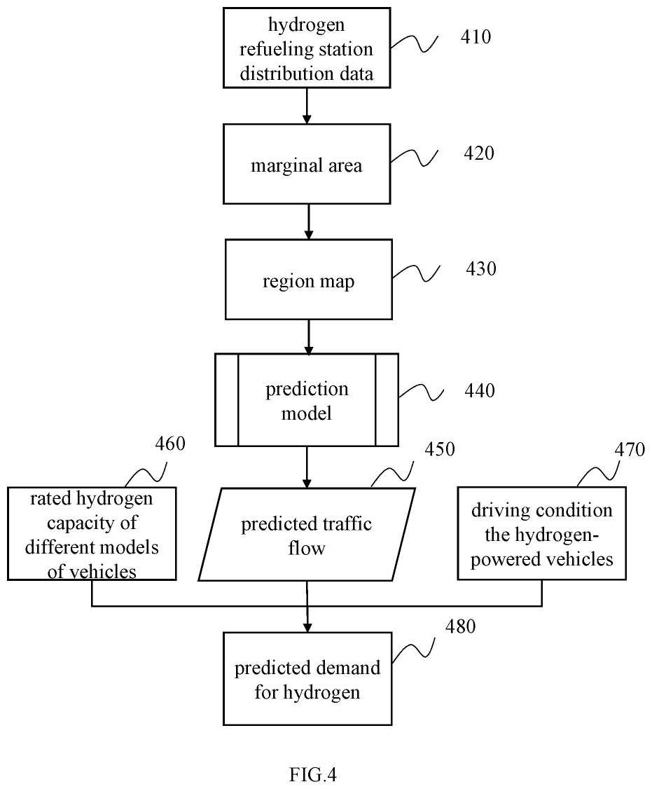

In some embodiments, the control device may be configured to determine the predicted demand for hydrogen for a future time period by performing the following operations: determining a marginal area based on the hydrogen refueling station distribution data; determining a predicted traffic flow of the marginal area in the future time period processing a region map corresponding to the marginal region using a prediction model, the prediction model being a machine learning model; and determining the predicted demand for hydrogen during the future time period, based on the predicted traffic flow, a rated hydrogen capacity of different models in the marginal area, and a travel condition (also referred to as driving condition) of a hydrogen-powered vehicle in the marginal area. For a more detailed description of the embodiment, see FIG. 4 and related description.

The hydrogen production strategy refers to the plan associated with the manufacture of the hydrogen by the decomposition device.

In some embodiments, the hydrogen production strategy comprises at least one of an operating power of the decomposition device, and moments of start and stop of the decomposition device. In some embodiments, the hydrogen production strategy may be represented by a sequence of moment of start/stops of the decomposition device and a sequence of operating power of the decomposition device at various time periods.

The operating power of the decomposition device refers to the operating power of the decomposition device when it decomposes water into the hydrogen and the oxygen. It should be noted that the decomposition device comprises a plurality of components, in which the electrolysis unit has the highest power and the other ancillary devices have lower power, so the operating power of the decomposition device may be regarded as the operating power of the electrolysis unit.

The moments of start/stop (also referred to as the moments of start and stop) of the decomposition device includes a start moment and a stop moment of the decomposition device. By the foregoing description, the moment of start/stop of the decomposition device may be regarded as the moment of start/stop of the electrolysis unit.

In some embodiments, the control device may determine a hydrogen production strategy based on the predicted demand for hydrogen and the hydrogen production cost during a future time period in a variety of ways. For example, the control device may determine the hydrogen production strategy based on the predicted demand for hydrogen during the future time period and the hydrogen production costs corresponding to the different time periods by querying a preset table. Stored in the preset table are a plurality of combinations and the operating power of the decomposition device and the moments of start/stop of the decomposition device corresponding to various combinations. The combinations may comprise an amount of used hydrogen and the hydrogen production cost corresponding to a time period. When querying the preset table, the predicted demand for hydrogen for a future time period corresponds to the amount of hydrogen used. The preset table may be set based on relevant experience or determined based on historical hydrogen production data. Further example, the control device may set the operating power of the decomposition device to a fixed value, and the control device selects, based on the rated hydrogen refueling capacity of the different hydrogen-powered vehicles, the period of time in which the hydrogen production cost is the lowest, and determines, by calculation, the moment of start/stop of the decomposition device.

In some embodiments, the control device is further configured to: determine the hydrogen production strategy based on the predicted demand for hydrogen, a current hydrogen content of the stationary hydrogen storage tank, and a maximum storage capacity of the stationary hydrogen storage tank.

The current hydrogen content of the stationary hydrogen storage tank is the amount of the hydrogen stored in the stationary hydrogen storage tank at the current time. The current hydrogen content of the stationary hydrogen storage tank may be detected by a gas detection device provided at the stationary hydrogen storage tank.

The maximum storage capacity of the stationary hydrogen storage tank may be obtained from technical data provided by the manufacturer of the tank. For example, the maximum storage capacity may be obtained from a corresponding nameplate identification of a corresponding stationary hydrogen storage tank. The corresponding maximum storage capacity may be different for different operating pressures and operating temperatures. For example, the maximum storage capacity corresponding to the operating pressure and operating temperature is queried from the datasheet of the stationary hydrogen storage tank.

In some embodiments, the control device may compare the predicted demand for hydrogen with the current hydrogen content of the stationary hydrogen storage tank and/or the maximum storage capacity of the stationary hydrogen storage tank, and determine the hydrogen production strategy based on the comparison result and the preset algorithm. The preset algorithm may be a pre-set computer rule for determining the hydrogen production strategy. The preset algorithm may be pre-saved in the control device for the control device to determine the hydrogen production strategy.

In some embodiments, the control device may determine the moment of start/stop of the decomposition device by a first predetermined algorithm in response to that the predicted demand for hydrogen is less than the current hydrogen content of the stationary hydrogen storage tank. In some embodiments, the first predetermined algorithm may include: constructing an objective function, solving an optimal solution of the objective function according to a first constraint and a first optimization objective, thereby obtaining the hydrogen production strategy.

In some embodiments, the first predetermined algorithm may include: constructing an objective function based on the unit price of electricity at various time periods, the operating power of the decomposition device, and the moments of start/stop of the decomposition device; solving the objective function based on the first constraint and the first optimization objective through an optimization algorithm According to the first constraint and the first optimization objective, the objective function is solved by the optimization algorithm until an optimal solution is found that satisfies the first constraints and makes the objective function reach the first optimization objective; the hydrogen production strategy corresponding to the optimal solution is selected as the final hydrogen production strategy.

In some embodiments, the optimization objects (i.e., variables) in the objective function include at least one of the moments of start/stop of the decomposition device, and the operating power of the decomposition device at various time periods.

In some embodiments, the first optimization objective is the lowest hydrogen production cost (e.g., the sum of the electricity cost and the equipment cost) for each time period.

In some embodiments, the first constraints include the amount of hydrogen production meeting the predicted demand for hydrogen, and the duration of hydrogen production meeting an operating duration requirement of the decomposition device. In some embodiments, the operating duration requirement of the electrolysis unit may be a time interval between a current moment and a start moment of a future time period greater than the operating duration.

The optimal solution may be the corresponding value of the optimization object when the objective function reaches the optimization goal. Optimization algorithms refer to algorithms that adjust the optimization object to meet the optimization objective; for example, the optimization algorithms may include gradient descent, genetic algorithms, linear programming, and nonlinear programming.

Solving the objective function may include direct solution (e.g., analytical solution, numerical solution solution) and multiple rounds of iterative solution. Multiple rounds of iteration refer to a series of cyclic processes of incremental improvement to reach the final goal. Exemplarily, the multi-round iterative solution process is as follows: determine the initial values of the optimized objects (i.e., variables) of the objective function, which may be generated based on historical data or randomly. Each round of iteration includes: calculating the results of the objective function based on the current values of the variables; adjusting the values of the variables according to the optimization algorithm; comparing the differences between the current solution and the solution of the previous round of iteration, and determining whether it satisfies termination condition or enter the next round of iteration; if the termination condition is satisfied, terminating the iteration process and taking the current solution as the optimal solution; otherwise, entering the next round of iteration and repeating the iteration process until the termination condition is satisfied. Wherein, the value of the variable in the first iteration is the initial value of the optimization object. The termination condition may be the convergence of the objective function, the stability of the solution, the upper limit of the number of iterations, and so on. At the end of the iterative process, the solution that satisfies the first constraint and makes the objective function reach the optimization goal is returned as the optimal solution.

Understandably, when the equipment cost is low, the electricity cost rises. When the operating power of the decomposition device and the operating duration of the decomposition device increase, the electricity cost increases and the equipment cost decreases. The variables affect each other. In some embodiments of the present disclosure, the hydrogen production strategy with the lowest total hydrogen production cost is solved by constructing an objective function and setting a first optimization objective to have the lowest total hydrogen production cost for each time period. The hydrogen production strategy with the lowest total hydrogen production cost can reduce the hydrogen production cost while meeting the predicted demand for hydrogen, thereby reducing the cost of the hydrogen production station.

In some embodiments, the control device may disconnect power to the electrolysis unit in response to the predicted demand for hydrogen being less than a product of the current hydrogen content of the stationary hydrogen storage tank and the predetermined factor. The preset coefficient may be a coefficient less than 1, and the value of the preset coefficient may be set empirically. For example, the range of the preset coefficient may be [0,0.6].

It should be noted that when the predicted demand for hydrogen is much less than the current hydrogen content of the stationary hydrogen storage tanks, the electrolysis unit may be shut down for cost savings to further save costs under the condition of meeting the predicted demand for hydrogen. While the ancillary device of the decomposition device has a lower electricity cost, the power source to the ancillary equipment may be left on without shutting down the ancillary equipment, and the power source to the electrolysis unit may be disconnected only, in order to ensure the rapid startup of the decomposition device.

In some embodiments, the control device may determine the operating power of the decomposition device based on a second predetermined algorithm in response to the predicted demand for hydrogen is greater than or equal to the current hydrogen content of the stationary hydrogen storage tank, and is less than the maximum storage capacity of the stationary hydrogen storage tank. In some embodiments, the second predetermined algorithm may include: constructing an objective function, solving an optimal solution of the objective function based on the second constraint and the second optimization objective, thereby obtaining the operating power.

In some embodiments, the second predetermined algorithm may include: constructing an objective function based on the unit price of electricity and the optimization object for each time period; according to the second constraints, the third constraints, and the second optimization objective, the objective function is solved by the optimization algorithm until an optimal solution that satisfies the second constraints and makes the objective function reach the second optimization objective; and the hydrogen production strategy corresponding to the optimal solution is selected as the final hydrogen production strategy. For more information about the optimization algorithm, please refer to the preceding description.

In some embodiments, the second optimization objective includes maximizing the amount of hydrogen produced and having the lower hydrogen production cost.

In some embodiments, the second constraint includes maximizing the amount of hydrogen produced and meeting the operating hour requirements of the decomposition device. The third constraint includes the hydrogen production cost being below a cost threshold. The cost threshold may be set as desired. For example, cost threshold=y*hydrogen selling price, and y is a profit factor; when lower profits are pursued (e.g., when the hydrogen refueling station is in a promotional state), y takes a smaller value, e.g., y takes 0.9, 1, etc.

In some embodiments, the second constraint further comprises that the operating power of the decomposition device does not exceed the electrical capacity of the power supply line. Power capacity is the maximum power capacity of the power supply line.

In some embodiments, the second objective function is solved by prioritizing the satisfaction of the second constraint, and then selecting a solution that satisfies the third constraint as the optimal solution from the solutions that satisfy the second constraint.

In some embodiments, when the hydrogen-powered vehicle is parked to the hydrogen refueling parking area for refueling, the conversion valve connects the transfer device to the storage device on the hydrogen-powered vehicle, and the control device may determine the operating power based on the second predetermined algorithm to obtain the maximum amount of hydrogen production.

In some embodiments of the present disclosure, setting the second constraints, the third constraints, and the second optimization objective to solve the objective function to obtain the hydrogen production strategy with the maximum amount of hydrogen production. The hydrogen production strategy that maximizes the amount of hydrogen production may satisfy a situation in which a hydrogen-powered vehicle is in urgent need of hydrogen.

In some embodiments, the control device may generate a control instruction based on the previously determined hydrogen production strategy, send the control instruction to the decomposition device to cause the decomposition device to execute the hydrogen production strategy based on the control instruction.

In some embodiments of the present disclosure, based on the first predetermined algorithm and the second predetermined algorithm, the control device can select the different hydrogen production strategies according to different situations to adapt to different hydrogen refueling scenarios.

In some embodiments, the control device issues an alert when the predicted demand for hydrogen is greater than the maximum storage capacity in the stationary hydrogen storage tank. The fact that the predicted demand for hydrogen is greater than the maximum storage capacity in the stationary hydrogen storage tank indicates that the predicted demand for hydrogen will not be met even if the stationary hydrogen storage tank is fully stocked with the hydrogen, and thus the alert needs to be issued early.

The alert is a prompt issued by the control device. The control device may give the alert by displaying an indication message, or by emitting sound, vibration, or the like, at a display or an interactive screen or a control panel of the hydrogen-powered vehicle, at a terminal device app of a user (e.g., a manager of the hydrogen refueling station, a driver of the hydrogen-powered vehicle, etc.), or the like. In some embodiments, the alert sent may include sending a prompt to the hydrogen refueling station manager that the hydrogen needs to be transported from another hydrogen refueling station or sending the alert to the hydrogen-powered vehicle that the hydrogen refueling station is low on gas.

In some embodiments, the control device may prioritize alerts to the hydrogen-powered vehicle whose hydrogen refueling demand is closest to the difference between the predicted demand for hydrogen use and the maximum storage capacity in the stationary hydrogen storage tank. For example, only three hydrogen-powered vehicles, A, B, and C, need to be refueled with hydrogen in a future time period, and need to be refueled with hydrogen of 5 kg, 10 kg, and 15 kg, respectively, at which time the predicted demand for hydrogen is 30 kg. At the same time, the maximum storage capacity of the fixed hydrogen storage tank is 20 kg, and the difference is 10 kg; at this time, it prioritizes to send a prompt of insufficient hydrogen refueling station gas to vehicle B, whose hydrogen refueling demand is closest to the difference, so as to facilitate vehicle B to go to other hydrogen refueling stations to refuel hydrogen.

In some embodiments of the present disclosure, by preferably sending the alert to the hydrogen-powered vehicle whose hydrogen refueling demand is closest to the difference, the total amount of the hydrogen required for the hydrogen-powered vehicle that ultimately comes to the refueling station may be made to be close to the maximum storage capacity in the stationary hydrogen storage tank. The hydrogen stored in the stationary hydrogen storage tank may be fully delivered to the hydrogen-powered vehicles, improving the utilization rate of the stationary hydrogen storage tank.

In some embodiments, the hydrogen refueling station further includes a heat exchanger, the heat exchanger configured to maintain a temperature of the decomposition device within a preset range. The preset range is a range in which the temperature of the decomposition device is preset. Exemplarily, the preset range is from 80 to 90° C., and the heat exchanger may maintain the temperature of the decomposition device in the range of 80 to 90° C. to maintain an optimal electrolysis efficiency of the decomposition device.

The heat exchanger is a device used for heat exchange that is capable of controlling the temperature of the decomposition device through cooling or heating. The heat exchanger may include a heating component (e.g., an electric heating coil, a thermostatic oven, etc.) and a cooling component (e.g., a cooling water tank, a cooling fan, etc.).

In some embodiments, the control device is configured to: determine a heating strategy for the heat exchanger based on a predicted demand for hydrogen and a current temperature of the decomposition device; generate the control instruction based on the heating strategy, send the control instruction to the heat exchanger to cause the heat exchanger to perform the heating strategy based on the control instruction.

In some embodiments, the current temperature of the decomposition device may be an average of the current temperatures of the components in the decomposition device. In some embodiments, the current temperature of the decomposition device may be the current temperature of a significant component of the decomposition device (e.g., the electrolysis tank). Wherein, the significant component refers to those whose work efficiency is significantly affected by temperature. The significant component may be determined by the control device or by a human preset. For example, if the electrolysis tank temperature exceeds 90° C., there will be a large amount of water vapor mixed with the hydrogen and the oxygen, which affects the efficiency of the system, and the continuous high temperature operation shortens the life of the asbestos diaphragm in the electrolysis tank; and if the temperature of the electrolysis tank is too low, it will affect the efficiency of electrolysis. The electrolysis tank may therefore be identified as a significant component.

In some embodiments, the current temperature of the decomposition device may be obtained by a temperature sensor, which may be provided inside the decomposition device (e.g., inside an electrolysis tank).

The heating strategy for the heat exchanger is a plan associated with the heat exchanger to perform heating. For example, the heating strategy may include the length of time that the heat exchanger is heated, the power of the heating, and so on.

In some embodiments, the heating strategy of the heat exchanger includes the moments of start/stop of the heat exchanger, a heating power of the heat exchanger to heat the water, and a heating power of the heat exchanger to heat the electrolysis tank.

In some embodiments, the moments of start/stop of the heat exchanger may include a start moment, a stop moment of a heating component in the heat exchanger. In some embodiments, the moments of start/stop of the heat exchanger may also include start moments, stop moments of the cooling components. The heating power of the heat exchanger to heat the water is the power of the heat exchanger to heat the water before it enters the electrolysis tank. The heating power of the heat exchanger to heat the electrolysis tank is the power of the heat exchanger to heat the electrolysis tank.

In some embodiments, the control device may, in response to a power failure of the electrolysis unit, determine a target temperature of the decomposition device based on a predicted demand for hydrogen; and determine the heating strategy based on the target temperature of the decomposition device and the current temperature of the decomposition device.

The target temperature is the temperature that the decomposition device needs to reach. As illustrated previously, the target temperature of the decomposition device may be a temperature that needs to be reached for a significant component of the decomposition device (e.g., the electrolysis tank).

In some embodiments, the target temperature of the decomposition device is positively correlated to the magnitude of the predicted demand for hydrogen, with the greater the predicted demand for hydrogen, the closer the target temperature of the decomposition device is to the preset range.

In some embodiments, the control device may determine the heating strategy in a variety of ways. For example, the control device constructs a heating feature vector based on the target temperature of the decomposition device, the current temperature of the decomposition device, and the corresponding desired heating duration; based on the heating feature vector, determine the reference vector that meets the predetermined matching conditions in the vector database, and determine the reference heating strategy corresponding to the reference vector as the heating strategy corresponding to the heating feature vector. The preset matching conditions may include the vector distance satisfying a distance threshold, the vector distance being minimized, or the like.

In some embodiments, the database of vectors includes a plurality of reference vectors and a reference heating strategy corresponding to each reference vector. The reference vectors are constructed based on a target temperature of the decomposition device, a heating duration, and an actual temperature of the decomposition device after that heating duration from historical data. The reference heating strategy corresponding to the reference vector may be determined based on the historical data.

In some embodiments of the present disclosure, by determining the heating strategy for the decomposition device based on the predicted demand for hydrogen when the electrolysis unit is powered off (when there is no hydrogen-powered vehicle to be charged with hydrogen at that time), the heating strategy for the heat exchanger can be determined to control the temperature of the decomposition device ahead of time when there is a predicted hydrogen-powered vehicle that needs to be charged with hydrogen in the future, so that when the hydrogen-powered vehicle is parked in the hydrogen refueling parking area, hydrogen can be produced efficiently and effectively right away, and the preparation time for hydrogen production may be reduced to improve the efficiency of hydrogen supply.

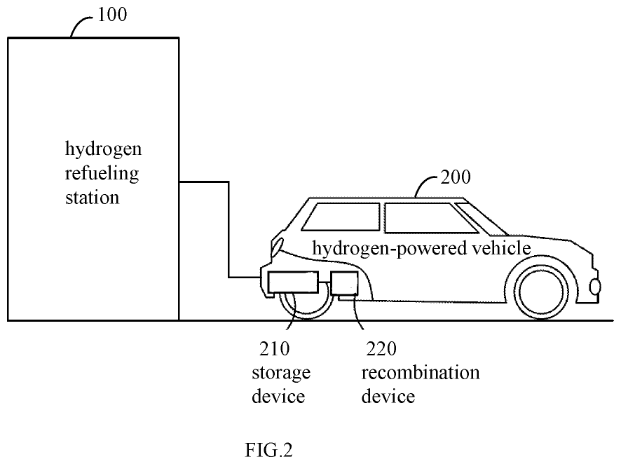

FIG. 2 is a schematic diagram of a hydrogen-powered vehicle shown in accordance with some embodiments of the disclosure. In some embodiments, as shown in FIG. 2, some embodiments of the present disclosure provide the hydrogen-powered vehicle, the hydrogen-powered vehicle being capable of receiving hydrogen provided from a hydrogen refueling station. The hydrogen refueling station may be the hydrogen refueling station as described in Embodiment 1. There is a storage device 30 and a recombination device 40 integrated in the hydrogen-powered vehicle of this embodiment.

In some embodiments, the storage device 30 is capable of holding the hydrogen provided by the hydrogen refueling station. In some embodiments, the storage device 30 includes a plurality of storage tanks, the plurality of storage tanks being disposed side-by-side, the plurality of storage tanks being capable of receiving the hydrogen from the hydrogen refueling station. Correspondingly, the plurality of storage tanks may be connected in parallel via piping while serving as a hydrogen refueling port for the hydrogen-powered vehicle via the inlet port of the main piping.

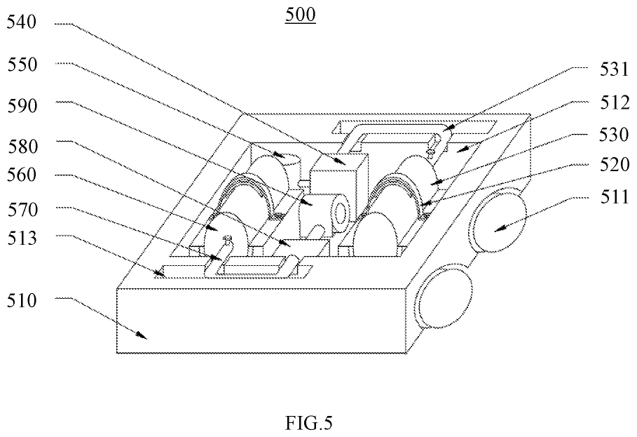

In some embodiments, the recombination device 40 is capable of receiving the hydrogen gas provided by the storage device 30, as well as the oxygen from the environment, and the hydrogen and the oxygen react in the recombination device 40 to produce an electric current. In some embodiments, the recombination device 40 is a clean cell including: a cathode, an anode, an electrolyte, and an external circuitry; the cathode is capable of receiving oxygen, the anode is capable of receiving the hydrogen, the electrolyte is disposed between the cathode and the anode, the hydrogen and oxygen react to produce an electric current. Thereby, the electric current generated by the recombination device 40 may be supplied to the electric equipment of the hydrogen-powered vehicle. For a more detailed description of the clean cell, see FIG. 5-FIG. 12 and relevant description.

Some embodiments of the present disclosure provide the hydrogen refueling system that can be used to refuel the hydrogen-powered vehicle. The hydrogen refueling system uses real-time hydrogen production and refueling, which in turn does not require the construction of large-scale hydrogen storage tanks, and eliminates the need for long-distance transportation of the hydrogen, which significantly reduces the cost of construction and operation of the hydrogen refueling system.

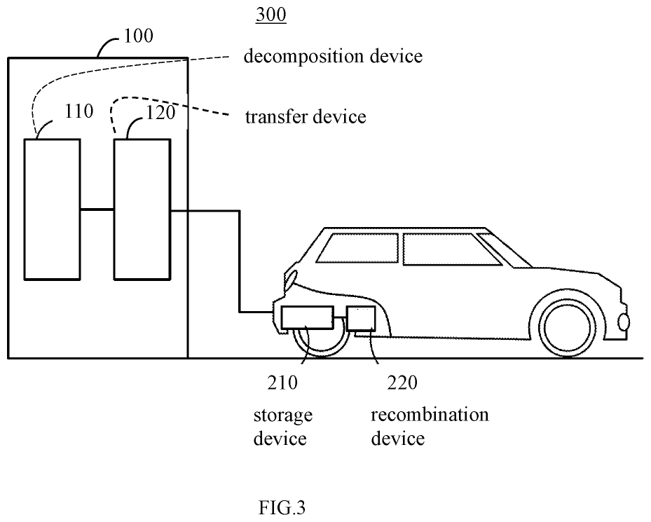

FIG. 3 is a schematic diagram of a hydrogen refueling system shown in accordance with some embodiments of the present disclosure. In some embodiments, the hydrogen refueling system includes: a decomposition device 100, a transfer device 200, a storage device 300, and a recombination device 400 as shown in FIG. 3. The decomposition device 100 is capable of decomposing water into the hydrogen and the oxygen in real time when the hydrogen-powered vehicle is located in the hydrogen refueling parking area; the hydrogen is capable of being delivered in real time to the storage device 300 of the hydrogen-powered vehicle via the transfer device 200; and the oxygen is capable of being discharged into the environment in real time via the transfer device 200. In a setup manner, the decomposition device 100 and the transfer device 200 may be integrated in a housing, and a hydrogen refueling connector of the transfer device 200 extends out of the housing to connect with a hydrogen refueling port of the vehicle.

In some embodiments, the decomposition device 100 employs the principle of electrolysis for hydrogen production. In some embodiments, the decomposition device 100 includes an electrolysis unit; the electrolysis unit includes: an electrolysis tank, electrodes, and a power source; the electrodes are provided in the electrolysis tank and connected to the power source; the electrolysis tank is capable of holding water to be electrolyzed. The water is decomposed into the hydrogen and the oxygen when the electrodes are energized. The hydrogen gas may be delivered to the vehicle by the transfer device 200, and the oxygen gas may be discharged directly into the environment.

In some embodiments, the power source may be a grid powered. In this way, the hydrogen refueling station may use the existing power grid as the energy source for hydrogen production, which in turn facilitates the construction and promotion of the hydrogen refueling station, and overcomes the inconvenience of hydrogen refueling for the hydrogen-powered vehicle. For example, the hydrogen refueling station may be set up in an area such as a residential area, an office area, beside a highway, a gas station, or the like.

In some embodiments, the transfer device 200 includes: a hydrogen delivery line and an oxygen discharge line; the hydrogen delivery line is coupled at one end to the decomposition device 100, and at the other end to the storage device 300; the oxygen discharge line is coupled at one end to the decomposition device 100, and the other end is connected to the environment. The other end of the hydrogen delivery line may be connected to a hydrogen refueling gun.

In some embodiments, the storage device 300, as well as the recombination device 400, may be integrated into the vehicle end. In this regard, the storage device 300 is capable of storing the hydrogen produced by the decomposition device 100. In some embodiments, the storage device 300 comprises a plurality of storage tanks, the plurality of storage tanks being disposed side-by-side, the plurality of storage tanks being capable of receiving the hydrogen from the decomposition device 100. Correspondingly, the plurality of storage tanks may be connected in parallel via piping while serving as a hydrogen refueling port for the hydrogen-powered vehicle via the inlet of the main piping.

In some embodiments, the recombination device 400 is capable of receiving the hydrogen gas provided by the storage device 300 as well as the oxygen gas from the environment, wherein the hydrogen gas and the oxygen gas react in the recombination device 400 to produce an electric current. In some embodiments, the recombination device 400 is a clean cell comprising: a cathode, an anode, an electrolyte, and an external circuit; the cathode is capable of receiving the oxygen, the anode is capable of receiving the hydrogen, the electrolyte is provided between the cathode and the anode, and the hydrogen and oxygen are reacted to produce an electrical current. The electrolyte is provided between the cathode and the anode, and the current generated by the reaction of the hydrogen and the oxygen is output through the external circuit. Thereby, the electric current generated by the recombination device 400 may be supplied to an electric device of the hydrogen-powered vehicle.

In some embodiments, the hydrogen refueling system further includes the control device. The control device is configured to: obtain the hydrogen production cost of the decomposition device; and determine the hydrogen production strategy based on predicted demand for hydrogen and hydrogen production cost at a future time period. For more details on the hydrogen production cost, the predicted demand for hydrogen, and the hydrogen production strategy, see FIG. 1 and related content.

In some embodiments, the control device is configured to determine the predicted demand for hydrogen by the following operations: determining the marginal area based on hydrogen refueling station distribution data; determining the predicted traffic flow based on the prediction model which processes a region map corresponding to the marginal area; and determining the predicted demand for hydrogen for future periods based on the predicted traffic flow, the rated hydrogen refueling capacity of different vehicle models in the marginal area, and the driving condition of the hydrogen-powered vehicle in the marginal area. For a more detailed description of this embodiment, see FIG. 4 and related contents.

In some embodiments, the hydrogen production cost includes the electricity cost and the equipment cost; to obtain the hydrogen production cost, the control device is configured to: determine the electricity cost of the decomposition device based on the price of electricity for the power supply line over different time periods; and based on the electricity cost and the equipment cost, determine the hydrogen production cost. For more details on the electricity cost consumption, the equipment cost, and the hydrogen production cost see FIG. 1 and related content.

In some embodiments, the control device is further configured to: determine the hydrogen production strategy based on the predicted demand for hydrogen, the current hydrogen content of the stationary hydrogen storage tank, and the maximum storage capacity of the stationary hydrogen storage tank. For a more detailed description of this embodiment see FIG. 1 and related content.

In some embodiments, the hydrogen refueling station further includes the heat exchanger, the heat exchanger being configured to maintain the temperature of the decomposition device within the preset range; the control device being further configured to: determine, based on the predicted demand for hydrogen and the current temperature of the decomposition device, the heating strategy; and generating a control instruction based on the heating strategy, sending the control instruction to the heat exchanger to cause the heat exchanger to execute the heating strategy based on the control instruction. For a more detailed description of the heat exchanger and the heating strategy, see FIG. 1 and related content.

The hydrogen refueling system disclosed in the embodiments of the present disclosure, when refueling a vehicle with the hydrogen, adopts a real-time hydrogen production and refueling method, thereby eliminating the need for constructing large-scale hydrogen storage tanks, and at the same time eliminating the need for the long-distance transportation of the hydrogen, which significantly reduces the construction cost and the system may be operated at a fraction of the cost of the hydrogen refueling system. In addition, the hydrogen refueling system of the present invention can adopt the existing electric power grid as the energy source for hydrogen production, which in turn is conducive to the construction and popularization of the hydrogen refueling station, and overcomes the inconvenience of hydrogen refueling for the hydrogen-powered vehicle.

FIG. 4 is a schematic diagram of an exemplary process of determining predicted demand for hydrogen shown in accordance with some embodiments of the present disclosure.

In some embodiments, as shown in FIG. 4, the control device is configured to determine a predicted demand for hydrogen by performing the following operations: determining a marginal area 420 based on hydrogen refueling station distribution data 410; determining a predicted traffic flow 450 of the marginal area in the future time period based on a prediction model 440 processing a region map 430 corresponding to the marginal area 420, the prediction model 440 being a machine learning model; and determining the predicted demand for hydrogen 480 during the future time period, based on the predicted traffic flow 450, the rated hydrogen capacity 460 of different models of vehicles in the marginal area 420, and the driving condition of the hydrogen-powered vehicles 470 in the marginal area 420.

The hydrogen refueling station distribution data is data relating to the distribution of the hydrogen refueling stations in a certain area. In some embodiments, the hydrogen refueling station distribution data may include the location coordinates and the regional extent of individual hydrogen refueling stations. In some embodiments, the hydrogen refueling station distribution data may be represented graphically. For example, the hydrogen refueling station distribution data may be represented graphically, similar to a map. The hydrogen refueling station distribution data represented graphically may be referred to as a hydrogen refueling station distribution map. The hydrogen refueling station distribution map reflects the coordinates of the location of each hydrogen refueling station and the extent of the area. In some embodiments, the hydrogen refueling station distribution data may be determined in a variety of ways, such as by accessing mapping software. For example, the hydrogen refueling station distribution data may be obtained by querying Google Maps for the hydrogen refueling station in a certain area to obtain relevant information the hydrogen refueling station distribution data.

The marginal area is the area within a preset distance from the current hydrogen refueling station. When the hydrogen-powered vehicle is located within the marginal area of a particular hydrogen refueling station, there is a high probability that the hydrogen-powered vehicle will select that the hydrogen refueling station for refueling, and will not select any other hydrogen refueling station for refueling.

In some embodiments, the preset distance may be preset by a human or by the system. In some embodiments, the preset distance may be negatively correlated to the density of the distribution of the hydrogen refueling station. For example, the preset distance may be related to the distribution of the hydrogen refueling station in such a way that the denser the distribution of the hydrogen refueling station is, the smaller the value of the preset distance.

In some embodiments, the control device may determine a denseness of the distribution of the hydrogen refueling station based on the hydrogen refueling station distribution data, determine the preset distance based on the denseness of the distribution of the hydrogen refueling stations, and thereby determine a region within the preset distance from the current hydrogen refueling station as the marginal area. In some embodiments, the control device may determine the denseness of the distribution of the hydrogen refueling station based on the hydrogen refueling station distribution data in multiple ways. For example, the control device may obtain the number of the hydrogen refueling station within a circular area of a predetermined radius thereof using the current hydrogen refueling station as the center of the circle, and determine a ratio of the number of the hydrogen refueling stations to the predetermined radius as the degree of denseness of the distribution of the hydrogen refueling station. Wherein the preset radius may be preset by a human being or by the system. The preset radius is larger than the preset distance range.

The predicted traffic flow is the number of vehicles that are likely to be present in the marginal area during a future time period.

The region map corresponding to the marginal area refers to a map consisting of roadway network data within the marginal area. In some embodiments, the region map may be a data structure comprising nodes and edges, with the edges connecting the nodes, and the nodes and edges may have attributes.

In some embodiments, the nodes of the region map may correspond to individual road surveillance systems (e.g., surveillance cameras, etc.) within the marginal area. The node attribute may reflect the vehicle data acquired by the road monitoring system over time. Vehicle data may include vehicle model data (e.g., brand and model of the vehicle, etc.), vehicle speed data, etc. The road monitoring system may determine the vehicle data based on the captured surveillance images through image recognition, algorithmic calculation, and so on. In some embodiments, the node attributes may reflect the vehicle data of the hydrogen-powered vehicle acquired by the road monitoring system over a period of time. The road monitoring system may tag the vehicle data of the hydrogen-powered vehicle from the raw vehicle data.

In some embodiments, an edge of the region map may be a roadway connecting a plurality of road monitoring systems. In some embodiments, the edges of the region map are directed edges, and the direction of the edges may be determined based on the manner in which the vehicles are traveling. In some embodiments, the edge attribute may include a length of roadway between two roadway monitoring systems.

Attributes of the nodes and edges may be determined by various methods based on the underlying data. The source of the data may be a method illustrated in other embodiments or other methods.

In some embodiments, the region map may be constructed based on roadway network data corresponding to the marginal area.

In some embodiments, the prediction model may be a machine learning model. In some embodiments, the prediction model may be a Graph Neural Network (GNN) model. The input to the prediction model may be the region map corresponding to the marginal area, and the output may be the predicted traffic flow of the marginal area in a future time period. The prediction model may also be other graph models, such as graph convolutional neural network model (GCNN), or adding other processing layers to the graph neural network model, modifying its processing methods, etc.

The prediction model is trained by the same or different processing devices based on training data. The training data includes training samples as well as labels. For example, the training samples may be a historical region map determined based on the historical data, the nodes of the historical region map and their attributes, the edges and their attributes are similar to the above illustration, and the labels may be historical traffic flows. The processing device may be a built-in processor of the hydrogen refueling system or a remote server. The remote server may be pre-trained to obtain a trained prediction model and save the trained prediction model in the control device.

An exemplary training process includes: inputting a plurality of training samples with labels into an initial prediction model, constructing a loss function from the labels and the output of the initial prediction model, iteratively updating the initial prediction based on the loss function via gradient descent or other methods parameters of the initial prediction model by gradient descent or other methods. The model training is completed when the preset conditions are met, and the trained prediction model is obtained. Wherein the preset conditions may be that the loss function converges, the number of iterations reaches a threshold, and so on.

In some embodiments, the control device may determine the predicted demand for hydrogen at a future time period based on the predicted traffic flow, the rated hydrogen refueling capacity of different vehicle models in the marginal area, and the driving condition of the hydrogen-powered vehicle in the marginal area by means of a predetermined algorithm.

In some embodiments, the control device may determine model data of the plurality of the hydrogen-powered vehicles in the marginal area based on the road monitoring system, and obtain the rated hydrogen refueling capacity of the plurality of the hydrogen-powered vehicles based on the model data from a database or a cloud-based platform (e.g., an official website of the vehicle brand, etc.).

In some embodiments, the driving condition of the hydrogen-powered vehicle within the marginal area may include an initial drivable mileage and a driven mileage of the hydrogen-powered vehicle. The initial drivable mileage is an average of a total number of miles that each of a plurality of the hydrogen-powered vehicles in the marginal area is capable of traveling prior to the start of the current trip. The driven mileage is an average of the number of miles that each of the plurality of the hydrogen-powered vehicles in the marginal area has already traveled during the trip.

In some embodiments, when the hydrogen-powered vehicle travels within the marginal area of the hydrogen refueling station, the hydrogen refueling station may initiate a request for constructing a data communication link to the control terminal of the hydrogen-powered vehicle, and after the data communication link has been successfully constructed, send the request for acquiring data to the control terminal of the hydrogen-powered vehicle to obtain the initial drivable mileage and the driven mileage of each hydrogen-powered vehicle, and then obtain the driving condition of the hydrogen-powered vehicle statistically.

In some embodiments, the control device may also obtain the traveled mileage of the hydrogen-powered vehicle based on the road monitoring system. For example, based on the plurality of image data acquired by the road monitoring system, the driven mileage of the hydrogen-powered vehicle is statistically obtained.

In some embodiments, the predetermined algorithm may be used to calculate an average amount of the hydrogen to be replenished for the hydrogen-powered vehicle based on the rated hydrogen refueling capacity and driving conditions of the hydrogen-powered vehicle, and then to determine the predicted demand for hydrogen based on the predicted traffic flow and the average amount of the hydrogen to be replenished. Exemplarily, the predetermined algorithm may be expressed as: the predicted traffic flow x the rated hydrogen refueling capacity x (miles traveled/initial drivable miles).

Some embodiments of the present disclosure can determine the marginal area through the distribution data of the hydrogen refueling station, and then determine the predicted total hydrogen demand through the traffic flow of the hydrogen-powered vehicle and different vehicle models using the prediction model, which makes the predicted demand for hydrogen more accurate, and can better control the cost.

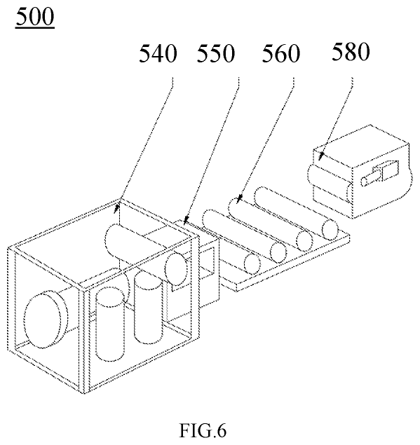

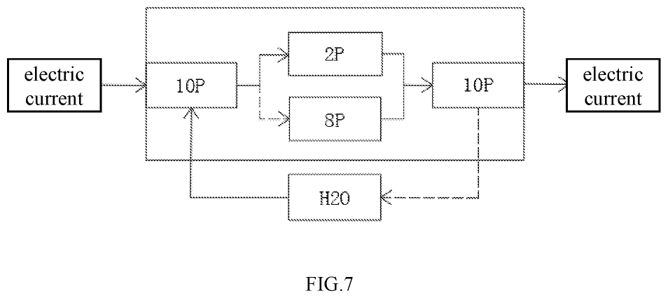

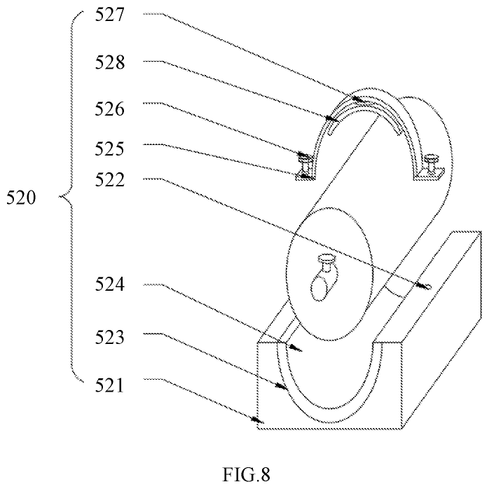

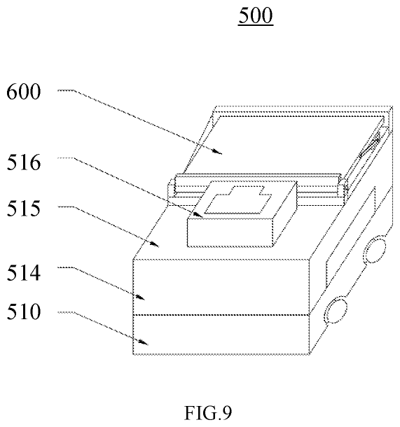

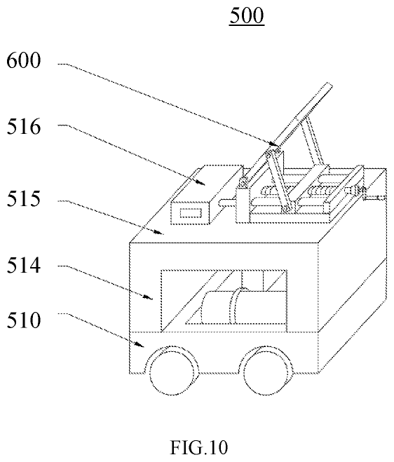

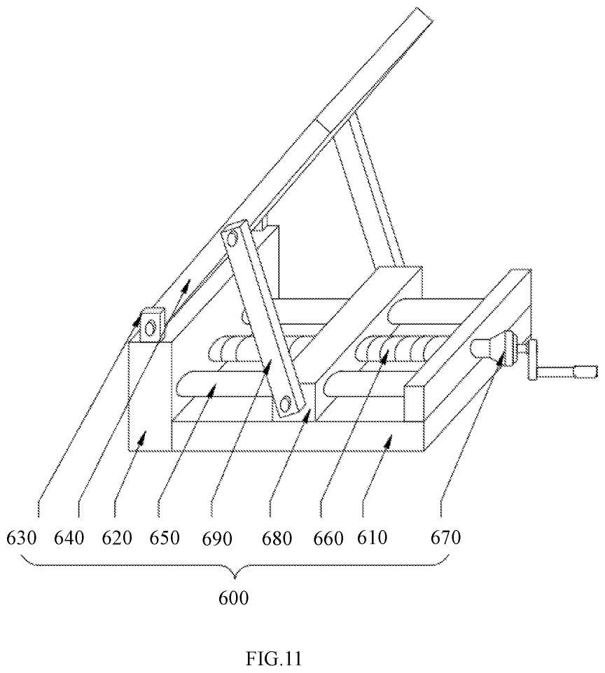

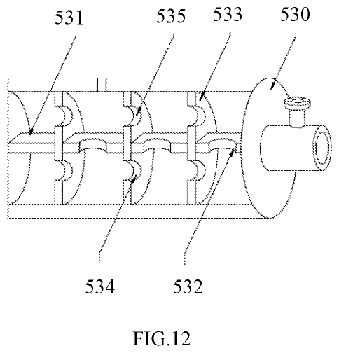

FIG. 5 is a schematic diagram of a structure of a chassis from a top view shown in accordance with some embodiments of the present disclosure; FIG. 6 is a schematic diagram of the structure of a recombination device shown in accordance with some embodiments of the present disclosure; FIG. 7 is a schematic diagram of the principle of operation of a recombination device shown in accordance with some embodiments of the present disclosure; FIG. 8 is a schematic diagram of a structure of a mounting assembly from a front view shown in accordance with some embodiments of the present disclosure; FIG. 9 is a schematic diagram of a structure of a recombination device from a front view shown in accordance with some embodiments of the present disclosure; FIG. 10 is a schematic diagram of a structure of a recombination device from a side view shown in accordance with some embodiments of the present disclosure; FIG. 11 is a schematic diagram of a structure of a photovoltaic module (also referred to as photovoltaic device) from a front view shown in accordance with some embodiments of the present disclosure; and FIG. 12 is a schematic diagram of the structure of the interior of a water storage tank shown in accordance with some embodiments of the present disclosure.

Some of the following embodiments may be understood with reference to FIG. 5 to FIG. 12, but the accompanying drawings are only a schematic illustration of some of these embodiments and do not constitute a limitation of the embodiments.

In some embodiments, the recombination device 220 is a clean cell (also referred to as clean battery). In some embodiments, as shown in FIG. 5, FIG. 9 and FIG. 10, the clean battery 500 includes a chassis 510 and a groove 512, the chassis 510 is provided with a moving wheel 511 in four directions, a pipe groove 513 is formed in the front and rear ends of the chassis 510, the groove 512 is arranged in the middle of the chassis 510, a water storage tank 520 is arranged at the right end of the groove 512, a feed pipe 531 is communicated at the output end of the water storage tank 520, and the end of the feed pipe 531 is connected with the decomposer 540. The left end of the decomposer 540 is connected with a proton transferor 550, the front end of the proton transferor 550 is connected with a proton storage tank 560, the output end of the proton storage tank 560 is connected with a return pipe 570, the end of the return pipe 570 is connected with a recombinator 580, the rear end of the recombinator 580 is electrically connected with the electric vehicle motor 590 and drives the moving wheel 511 to rotate through a transmission device, and the decomposer 540 decomposes the ten protons of water into two and eight, and two of the protons are directly stored in the proton storage tank 560 through the proton transferor 550, and eight of the protons are directly stored in nature, the recombinator 580 recombines the two protons and eight protons into water and releases electrons simultaneously, and the recombinator 580 transmits electrical energy to the electric vehicle motor 590 and converts it into mechanical energy.

Specifically operated as follows, the present application arranges the water storage tank 520, the decomposer 540, the proton transferor 550, the proton storage tank 560, the recombinator 580, and the electric vehicle motor 590 in a reasonable structure in the groove 512 in the middle of the chassis 510. The feed pipe 531 and the return pipe 570 pass through the corresponding pipe grooves 513 respectively to avoid the clutter of pipelines inside the groove 512, the decomposer 540 decomposes the ten protons of water into two and eight, and two of the protons are stored in the proton storage tank 560 directly by the proton transferor 550. Eight of the protons are stored in nature directly, and the recombinator 580 reconstitutes the two protons and eight protons into water simultaneously, the recombinator 580 reconfigures the two protons and eight protons into water while releasing electrons, and the recombinator 580 delivers electrical energy to the electric vehicle motor 590 to convert it into mechanical energy. Further, the electric vehicle motor 590 drives the moving wheel 511 to rotate through the transmission device, and as can be seen from the foregoing, the proton battery proposed in the present application is a battery that is integrated with nature, with the useful protons stored in the battery during the storage reaction, the excess proton is stored in nature, and the excess protons are retrieved from nature during the discharge reaction, so that the number of effective protons inside the battery is much larger than that of the current mainstream batteries, which solves the pain point of the low mass energy density The important energy storage material of the battery is water, which does not pollute the environment, and is truly a clean cell, and the water resources may be obtained from multiple channels without the risk of a choke point.

Referring to FIG. 5 and FIG. 8, both ends of the groove 512 are fixedly mounted with mounting assembly 520, the mounting assembly 520 comprises the bottom bracket 501, threaded hole 502, bottom groove 503 and flame retardant pad 504 (also referred to as fire-resistant pad), and the threaded holes 502 are formed in both sides of bottom bracket 501. Bottom groove 503 is formed in the bottom of the bottom bracket 501, and an inner wall of the bottom groove 503 is attached with flame retardant pad 504. The mounting assembly 520 further comprises pipe clamp 505 and bolt 506, bottom bracket 501 is securely fastened with a pipe clamp 505 at the top, and the pipe clamp 505 is fixed with the threaded hole 502 through bolts 506 at both ends. The mounting assembly 520 further comprises a damper 507 and a top plate 508, a damper 507 is fixedly mounted on the inner wall of the pipe clamp 505, a top plate 508 is elastically connected at the bottom end of the damper 507, the gap between opposite surfaces of the top plate 508 and the bottom groove 503 is matched with the water storage tank 520 and the proton storage tank 560, and a transverse bar 18 is horizontally fixed inside the water storage tank 520. The surface of the transverse bar 18 is provided with a connecting hole 19 at equal intervals along its extension direction, three wave-proof plates 20 are set up inside the water storage tank 520, the wave-proof plate 20 is welded and fixed at the butt of the transverse bar 18, a liquid flow hole 21 is formed through the bottom end of the wave-proof plate 20, and a ventilation hole 22 is formed through the top end of the wave-proof plate 20.

The specific operation is as follows, the water storage tank 520 and the proton storage tank 560 are both equipped with mounting components 520, the water storage tank 520 and the proton storage tank 560 are stably installed in the bottom bracket 501 through the restraint of the pipe clamp 505, the inner wall of the pipe clamp 505 is elastically connected to the top plate 508 through the damper 507 simultaneously, and the cross-shaped grid anti-sway plate located in the water storage tank 520 can effectively reduce the influence of liquid sloshing on the overall attitude stability, and guarantee the stable operation of the system. Wherein the cross-shaped grid anti-sway plate is formed by staggering the transverse bar 18 that is horizontally arranged and the wave-proof plate 20 that is vertically arranged, the setting of the transverse bar 18 strengthens the structural rigidity of the wave-proof plate 20, the liquid flow hole 21 that is formed at the bottom of the wave-proof plate 20 is convenient for liquid injection and drainage, and inhibits the fluctuation of the liquid in the state of motion. The ventilation hole 22 that is formed at the top of the wave-proof plate 20 ensures that when loading and unloading liquid, air may be connected through each sub-compartment to balance the air pressure.

Referring to FIG. 9 and FIG. 10, two ends of the chassis 510 is fixedly mounted with brackets 14, the top end of the bracket 14 is fixedly mounted with a roof 15, the front end of the roof 15 is fixedly mounted with an inverter 16, and the rear end of the roof 15 is fixedly mounted with a photovoltaic module 17. The photovoltaic module 17 comprises a base 1701, an end plate 1702, a rotating pin 1703 and a photovoltaic panel 1704, the two ends of the base 1701 are integrally fixedly mounted with end plates 1702, and a rotating pin 1703 is fixedly mounted at the top of the left end plate 1702, a photovoltaic panel 1704 is rotatably installed inside the rotating pin 1703. The photovoltaic module 17 further comprises a guide rod 1705, a screw rod 1706 and a crank handle 1707, guide rods 1705 are fixedly connected to two opposite sides of the two sides of the end plate 1702, a screw rod 1706 is rotatably mounted in the middle of the opposite planes of the end plate 1702 on both sides, and a crank handle 1707 is coaxially fixed at the right end of the screw rod 1706. The photovoltaic module 17 further comprises a slider 1708 and a connecting rod 1709, the middle part of the screw rod 1706 is threaded with a slider 1708, the slider 1708 is in sliding fit with the guide rods 1705 on both sides, the two ends of the slider 1708 are rotatably connected with a connecting rod 1709, and the end of the connecting rod 1709 is rotatably connected with both ends of the photovoltaic panel 1704.

The specific operation is as follows, in order to implement the application demand of clean energy, the application abandons the power generation mode of traditional fossil energy, absorbs solar energy through photovoltaic module 17 and converts it into electric energy, and then provides energy supply for the process of electrolysis of water by decomposer 540, and simultaneously solves the technical problem that photovoltaic panel 1704 is fixed on the bracket 14, and only placed at a fixed inclination angle, so as to affect the power generation. By arranging the photovoltaic module 17 in the present application, the screw rod 1706 may be driven to rotate through the crank handle 1707, and the inclination angle of the photovoltaic panel 1704 is adjusted through the connecting rod 1709 under the threaded fit of the screw rod 1706 and the middle slider 1708, so that the photovoltaic panel 1704 may be pitched and adjusted with the change of the lighting angle.

To sum up, the embodiments arrange the water storage tank 520, the decomposer 540, the proton transferor 550, the proton storage tank 560, the recombinator 580 and the electric vehicle motor 590 in a reasonable structure in the groove 512 of the middle part of the chassis 510. The feed pipe 531 and the return pipe 570 pass through the corresponding pipe groove 513 respectively, so as to avoid the messiness of the internal pipeline of the groove 512. The water storage tank 520 and the proton storage tank 560 are equipped with mounting components 520, and the water storage tank 520 and the proton storage tank 560 are stably installed in the bottom bracket 501 through the restraint of the pipe clamp 505. At the same time, the roof 508 which is connected to the inner wall of the pipe clamp 505 is elastically connected by the damper 507 and the cross-shaped grid anti-sway plate located in the water storage tank 520 may effectively reduce the influence of liquid sloshing on the overall attitude stability, and ensure the stable operation of the system. Wherein, the cross-shaped grid anti-sway plate is staggered by the transverse bar 18 that is horizontally arranged and the wave-proof plate 20 that is vertically arranged, the setting of the transverse bar 18 strengthens the structural rigidity of the wave-proof plate 20, and the liquid flow hole 21 that is formed at the bottom of the wave-proof plate 20 is convenient for liquid injection and drainage, and inhibits the fluctuation of liquid in the moving state. The ventilation hole 22 that is formed at the top of the wave-proof plate 20 ensures that when loading and unloading liquid, air may be connected through each sub-compartment to balance the air pressure. When in use, solar energy is absorbed and converted into electrical energy through photovoltaic module 17, and then energy supply is provided for the process of electrolysis of water by decomposer 540 to produce protons. Specifically, the screw rod 1706 may be driven to rotate through the crank handle 1707, and under the threaded fit of the screw rod 1706 and the middle slider 1708, the inclination angle of the photovoltaic panel 1704 is adjusted through the connecting rod 1709, so that the photovoltaic panel 1704 may be pitched and adjusted with the change of the illumination angle, and a better photovoltaic power generation efficiency is obtained between 20 degrees and 45 degrees. The decomposer 540 decomposes ten protons of water into two and eight, and two of the protons are directly stored in the proton storage tank 560 through the proton transferor 550, and eight of the protons are directly stored in nature, thereafter, the recombinator 580 recombines the two protons and eight protons into water and releases electrons simultaneously, and the recombinator 580 transmits the electrical energy to the electric vehicle motor 590 and converts it into mechanical energy, and the electric vehicle motor 590 further drives the moving wheel 511 to rotate through the transmission device.

Embodiments of the present disclosure provide a highly efficient clean cell with the following beneficial effects:

1. Ten protons of water are decomposed into two and eight by a decomposition device, and two of the protons are stored directly in a proton storage tank through a proton transferor, and eight of the protons are stored directly in nature, and thereafter, a recombinator recombines the two protons and the eight protons into water while releasing electrons, and the recombinator delivers electrical energy to an electric vehicle motor to convert mechanical energy. The recombinator recombines the two protons and eight protons into water and releases electrons at the same time, and transfers the electric energy to the electric vehicle motor to be converted into mechanical energy. As may be seen from the foregoing, the proton battery proposed in the present application is a battery that is integrated with nature, with the useful protons being stored in the battery during the storage reaction, the excess mass of the protons being stored in nature, and then being retrieved from nature during the discharge reaction, so that the effective number of protons within the battery is much larger than that of current mainstream batteries. Far greater than the current mainstream batteries, solving the pain point of the low mass energy density, the battery's important energy storage material is water, which will not cause pollution to the environment, water resources may be obtained from multiple channels, there is no neck risk, and the battery is the real clean cell.

2. The water storage tank, decomposer, proton transferor, proton storage tank, recombinator and electric vehicle motor are arranged in the middle of the chassis in the groove in a reasonable structure, and the feeding pipe and the return pipe are respectively passed by the corresponding pipe groove, so as to avoid the mess of the pipelines inside the groove. The water storage tank and the proton storage tank are equipped with mounting components, which realize the stable installation of the water storage tank and the proton storage tank in the bottom bracket through the binding of pipe clamps, while the top plate elastically connected to the inner wall of the pipe clamps through a damper, and the cross-shaped grid anti-shaking plate located in the water storage tank may effectively reduce the impact of liquid shaking on the stability of the overall attitude to ensure the stable operation of the system. The cross-shaped grid anti-shaking plate consists of a cross-shaped bar and a longitudinal bar, which are set up in a transverse direction and a longitudinal direction. The set of transverse bars can strengthen the structural rigidity of the plate, the bottom of the plate opened the liquid flow holes can facilitate the liquid injection and exhaust, and inhibit liquid fluctuations in the state of motion, the top of the plate opened the air holes can ensure that when loading and unloading of liquids, the air can be connected to the balance of the pressure through the various sub-partitions.

3. In order to carry out the demand for the application of clean energy, this application abandons the traditional fossil energy generation method, absorbs solar energy through the photovoltaic module and converts it into electric energy, which in turn provides the energy supply for the process of electrolysis of water in the disintegrator to produce protons, and at the same time, in order to solve the technical problems of the existing technology, the photovoltaic panel may only be placed at a fixed inclination angle after being fixed on the bracket, and the power generation capacity is affected. In the present application, through the setting of the photovoltaic module, the silk rod may be driven to rotate by the crank, and the tilt angle of the photovoltaic panel is adjusted by the connecting rod under the threaded cooperation between the silk rod and the central slider, so that the photovoltaic panel may be adjusted to the pitch following the change of the angle of the illumination, and the better photovoltaic power generation efficiency may be obtained between 20 and 45 degrees.

4. At the subatomic level with a basic formula to unify the various electrochemical batteries (aP⇔bP+cP), efficiency of the market mainstream lithium iron phosphate battery (112 P⇔3 P+109 P) and lithium ternary batteries (82 P⇔3 P+79 P) are compared with that of the proton battery (10 P⇔2 P+8 P). From the above comparisons, it may be seen that the proton battery in this application has the highest efficiency, and the proposal of proton battery is a refreshing change to the traditional perception of the hydrogen energy industry (the paradigm proposed by Japan). Focusing the integration of the entire industrial chain into a standardized product and proposing a paradigm for energy storage batteries is structural innovation.

The basic concepts have been described above, and it is apparent to those skilled in the art that the foregoing detailed disclosure serves only as an example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure, such as “an embodiment”, “an embodiment”, and/or “some embodiment” means a feature, structure, or characteristic associated with at least one embodiment of the present disclosure. Accordingly, it should be emphasized and noted that two or more references in this present disclosure, at different locations, to “an embodiment” or “some embodiments” or “an alternative embodiment” in different places in this present disclosure do not necessarily refer to the same embodiment. In addition, certain features, structures, or characteristics of one or more embodiments of the present disclosure may be suitably combined.

In addition, unless expressly stated in the claims, the order of the processing elements and sequences, the use of numerical letters, or the use of other names as described in this present disclosure are not intended to qualify the order of the processes and methods of this present disclosure. While some embodiments of the invention that are currently considered useful are discussed in the foregoing disclosure by way of various examples, it is to be understood that such details serve only illustrative purposes, and that additional claims are not limited to the disclosed embodiments, rather, the claims are intended to cover all amendments and equivalent combinations that are consistent with the substance and scope of the embodiments of this present disclosure. For example, although the implementation of various components described above may be embodied in a hardware device, it may also be implemented as a software only solution, e.g., an installation on an existing server or mobile device.

Similarly, it should be noted that in order to simplify the presentation of the disclosure of this present disclosure, and thereby aid in the understanding of one or more embodiments of the invention, the foregoing descriptions of embodiments of the present disclosure sometimes group multiple features together in a single embodiment, accompanying drawings, or a description thereof. However, this method of disclosure does not imply that the objects of this present disclosure require more features than those mentioned in the claims. Rather, claimed subject matter may lie in less than all features of a single foregoing disclosed embodiment.

Finally, it should be understood that the embodiments described in this present disclosure are only used to illustrate the principles of the embodiments of this present disclosure. Other deformations may also fall within the scope of this present disclosure. As such, alternative configurations of embodiments of the present disclosure may be considered to be consistent with the teachings of this present disclosure as an example, not as a limitation. Correspondingly, the embodiments of the present disclosure are not limited to the embodiments expressly presented and described herein.

What is claimed is:

1. A hydrogen refueling station for refueling a hydrogen-powered vehicle, comprising a hydrogen refueling parking area where a decomposition device and a transfer device are provided, wherein
the decomposition device is configured to decompose water into hydrogen and oxygen when the hydrogen-powered vehicle is located in the hydrogen refueling parking area; the hydrogen is delivered to a storage device of the hydrogen-powered vehicle, and the oxygen is discharged into an environment via the transfer device.

2. The hydrogen refueling station according to claim 1, wherein the decomposition device comprises an electrolysis unit which includes an electrolysis tank, an electrode, and a power source, wherein the electrode is disposed in the electrolysis tank and connected to the power source; the electrolysis tank is configured to accommodate water which is decomposed into hydrogen and oxygen when the electrode is energized; and the power source is supplied by an electrical grid.

3. The hydrogen refueling station according to claim 1, wherein the transfer device comprises: a hydrogen delivery line and an oxygen discharge line; the hydrogen delivery line is connected to the decomposition device at one end and to the storage device at the other end; the oxygen discharge line is connected to the decomposition device at one end and to the environment at the other end.

4. The hydrogen refueling station according to claim 1, further comprising a control device which is configured to:
obtain a hydrogen production cost of the decomposition device; and
determine a hydrogen production strategy based on a predicted demand for hydrogen in a future time period and the hydrogen production cost, the hydrogen production strategy comprising at least one of operating power of the decomposition device or moments of start and stop of the decomposition device.

5. The hydrogen refueling station according to claim 4, wherein the control device is configured to determine the predicted demand for hydrogen by the following operations:
determining a marginal area based on hydrogen refueling station distribution data;
determining a predicted traffic flow of the marginal area in the future time period by processing a region map corresponding to the marginal area using a prediction model, the prediction model being a machine learning model; and
determining the predicted demand for hydrogen in the future time period, based on the predicted traffic flow, a rated hydrogen capacity of each of different models of hydrogen-powered vehicles in the marginal area, and a driving condition of each hydrogen-powered vehicle in the marginal area.

6. The hydrogen refueling station according to claim 4, wherein the hydrogen production cost comprises an electricity cost and an equipment cost; and in order to obtain the hydrogen production cost, the control device is configured to:
determine the electricity cost used by the decomposition device based on a price of electricity over different time periods; and
determine the hydrogen production cost based on the electricity cost and the equipment cost.

7. The hydrogen refueling station according to claim 4, wherein the control device is further configured to:
determine the hydrogen production strategy based on the predicted demand for hydrogen, a current hydrogen content of a stationary hydrogen storage tank, and a maximum hydrogen storage capacity of the stationary hydrogen storage tank.

8. The hydrogen refueling station according to claim 7, wherein the control device is further configured to:
when the predicted demand for hydrogen is greater than the maximum storage capacity of the stationary hydrogen storage tank, send an alert to a manager of the hydrogen refueling station that the hydrogen needs to be transported from another hydrogen refueling station or to a hydrogen-powered vehicle that the hydrogen refueling station is lack of hydrogen.

9. The hydrogen refueling station according to claim 7, wherein the control device is further configured to
determine, by a first predetermined algorithm, the moments of start and stop of the decomposition device when the predicted demand for hydrogen is less than the current hydrogen content of the stationary hydrogen storage tank.

10. The hydrogen refueling station according to claim 7, wherein the control device is further configured to
determine the operating power of the decomposition device based on a second predetermined algorithm when the predicted demand for hydrogen is greater than the current hydrogen content of the stationary hydrogen storage tank and less than a maximum hydrogen storage capacity of the stationary hydrogen storage tank.

11. The hydrogen refueling station according to claim 6, wherein the hydrogen refueling station further comprises a heat exchanger, the heat exchanger being configured to maintain a temperature of the decomposition device within a preset range;
the control device is further configured to
determine a heating strategy for the heat exchanger based on the predicted demand for hydrogen and a current temperature of the decomposition device; and
generate a control instruction based on the heating strategy, and send the control instruction to the heat exchanger to cause the heat exchanger to execute the heating strategy in accordance with the control instruction.

12. A hydrogen-powered vehicle capable of receiving hydrogen supplied from the hydrogen refueling station of claim 1, comprising a storage device and a recombination device, wherein
the storage device is configured to store the hydrogen provided by the hydrogen refueling station; the recombination device is configured to receive the hydrogen provided by the storage device as well as oxygen from the environment, the hydrogen and oxygen reacting in the recombination device to produce an electric current.

13. The hydrogen-powered vehicle according to claim 12, wherein the storage device comprises a plurality of storage tanks, the plurality of storage tanks being disposed side-by-side, the plurality of storage tanks being all capable of receiving the hydrogen from the hydrogen refueling station.

14. The hydrogen-powered vehicle according to claim 12, wherein the recombination device is a clean cell, the clean cell comprising: a cathode, an anode, an electrolyte, and an external circuit;
the cathode being used to receive the oxygen and the anode being used to receive the hydrogen,
the electrolyte being provided between the cathode and the anode, and
the electric current generated by the reaction of the hydrogen and oxygen being output through the external circuit.

15. A hydrogen refueling system comprising: a decomposition device, a transfer device, a storage device, and a recombination device; wherein
the decomposition device is configured to decompose water into hydrogen and oxygen; the transfer device is configured to deliver the hydrogen into the storage device and to discharge the oxygen into an environment; the storage device is configured to store the hydrogen delivered from the transfer device; the recombination device is configured to receive the hydrogen from the storage device and the oxygen from the environment, the hydrogen and oxygen reacting in the recombination device to produce an electric current.

16. The hydrogen refueling system according to claim 15, further comprising a control device which is configured to:
obtain a hydrogen production cost of the decomposition device; and
determine a hydrogen production strategy based on a predicted demand for hydrogen in a future time period and the hydrogen production cost; the hydrogen production strategy comprising at least one of operating power of the decomposition device or moments of start and stop of the decomposition device.

17. The hydrogen refueling system according to claim 16, wherein the control device is configured to determine the predicted demand for hydrogen by the following operations:
determining a marginal area based on hydrogen refueling station distribution data;
determining a predicted traffic flow of the marginal area in the future time period by processing a region map corresponding to the marginal area using a prediction model, the prediction model being a machine learning model; and
determining the predicted demand for hydrogen in the future time period based on the predicted traffic flow, a rated hydrogen capacity of each of different models of hydrogen-powered vehicles in the marginal area, and a driving condition of each hydrogen-powered vehicle in the marginal area.

18. The hydrogen refueling system according to claim 16, wherein the hydrogen production cost comprises an electricity cost and an equipment cost; and in order to obtain the hydrogen production cost, the control device is configured to:
determine the electricity cost used by the decomposition device based on a price of electricity over different time periods; and
determine the hydrogen production cost based on the electricity cost and the equipment cost.

19. The hydrogen refueling system according to claim 16, wherein the control device is further configured to:
determine the hydrogen production strategy based on the predicted demand for hydrogen, a current hydrogen content of a stationary hydrogen storage tank, and a maximum hydrogen storage capacity of the stationary hydrogen storage tank.

20. The hydrogen refueling system according to claim 19, wherein the hydrogen refueling station further comprises a heat exchanger, the heat exchanger being configured to maintain the temperature of the decomposition device within a preset range;
the control device is further configured to:
determine a heating strategy for the heat exchanger based on the predicted demand for hydrogen and a current temperature of the decomposition device; and
generate a control instruction based on the heating strategy, and send the control instructions to the heat exchanger to cause the heat exchanger to execute the heating strategy in accordance with the control instruction.
